(19) United States
(12) Patent Application Publication
(10) Pub. No.: US 2015/0156227 A1
(43) Pub. Date: Jun. 4, 2015

(54) Synchronize Tape Delay and Social Networking Experience

(71) Applicant: International Business Machines Corporation, Armonk, NY (US)

(72) Inventors: Kimberly D. McCall, Leander, TX (US); Henri F. Meli, Cary, NC (US); Michael S. Thomason, Raleigh, NC (US); Yingxin Xing, Durham, NC (US)

(21) Appl. No.: 14/495,040

(22) Filed: Sep. 24, 2014

Related U.S. Application Data
(63) Continuation of application No. 14/094,636, filed on Dec. 2, 2013.

(51) Int. Cl. H04L 29/06; G06Q 50/00

(52) U.S. Cl. CPC H04L 65/403; G06Q 50/01

(57) ABSTRACT

An approach that delays presentation of social media communications corresponding to an event is provided. In the approach, social media communications received during an initial presentation of the event are stored. A time delay associated with each of the social media communications is recorded with the time delay being from the start time of the initial presentation of the event. During subsequent playback of the event, the approach retrieves the stored social media communications and presents the retrieved social media communications based upon the time delay associated with each of the communications from the start time of the subsequent event playback.

### BACKGROUND OF THE INVENTION

A key contribution to knowledge is the ability to experience an event within one's social network. Experiencing an event within one's social network can be understood as the ability of watching an event, such as a sports game being broadcast on television, and at the same time interacting with one's social network about the event itself. This could involved exchanging/responding to event-related SMS messages during a game or movie, event-related comments using a social network website, as well as likes and dislikes, event-related tweets, event-related voice messages and other event-related social network exchanges, while the event is actually happening.

Many people have very busy schedules and there are lots of event choices occurring every day. This results in time conflicts during which people cannot always watch events live. Some people enjoy experiencing live events and at the same time interacting with friends, family, or others within their social circle. If a person misses an event, then there is a high probability that they will be informed about the outcome by people within their social network one way or another, eliminating the suspense, such as the outcome of a game. Today, using various devices and technology, it is relatively easy to record events and watch them later in tape delay mode. However, when watching an event at a later time, a person loses the social interaction which would have otherwise occurred if the event was being watched live.

### SUMMARY

An approach that delays presentation of social media communications corresponding to an event is provided. In the approach, social media communications received during an initial presentation of the event are stored. A time delay associated with each of the social media communications is recorded with the time delay being from the start time of the initial presentation of the event. During subsequent playback of the event, the approach retrieves the stored social media communications and presents the retrieved social media communications based upon the time delay associated with each of the communications from the start time of the subsequent event playback.

The foregoing is a summary and thus contains, by necessity, simplifications, generalizations, and omissions of detail; consequently, those skilled in the art will appreciate that the summary is illustrative only and is not intended to be in any way limiting. Other aspects, inventive features, and advantages of the present invention, as defined solely by the claims, will become apparent in the non-limiting detailed description set forth below.

### BRIEF DESCRIPTION OF THE DRAWINGS

The present invention may be better understood, and its numerous objects, features, and advantages made apparent to those skilled in the art by referencing the accompanying drawings, wherein:

FIG. 1 is a block diagram of a data processing system in which the methods described herein can be implemented;

FIG. 2 provides an extension of the information handling system environment shown in FIG. 1 to illustrate that the methods described herein can be performed on a wide variety of information handling systems which operate in a networked environment;

FIG. 3 is a component diagram showing the various components used in detecting and hiding spoiler information in a collaborative setting;

FIG. 4 is a depiction of a flowchart showing the logic used in spoiler alert user setup processing;

FIG. 5 is a depiction of a flowchart showing the logic used in spoiler alert setup by the content provider;

FIG. 6 is a depiction of a flowchart showing the logic used by a spoiler identification engine;

FIG. 7 is a depiction of a flowchart showing the logic performed to handle a user's individual custom spoiler settings; and

FIG. 8 is a depiction of a flowchart showing the logic used to playback recorded content along with a synchronized rendering of the posts that occurred during the original performance of the content.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer, server, or cluster of servers. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

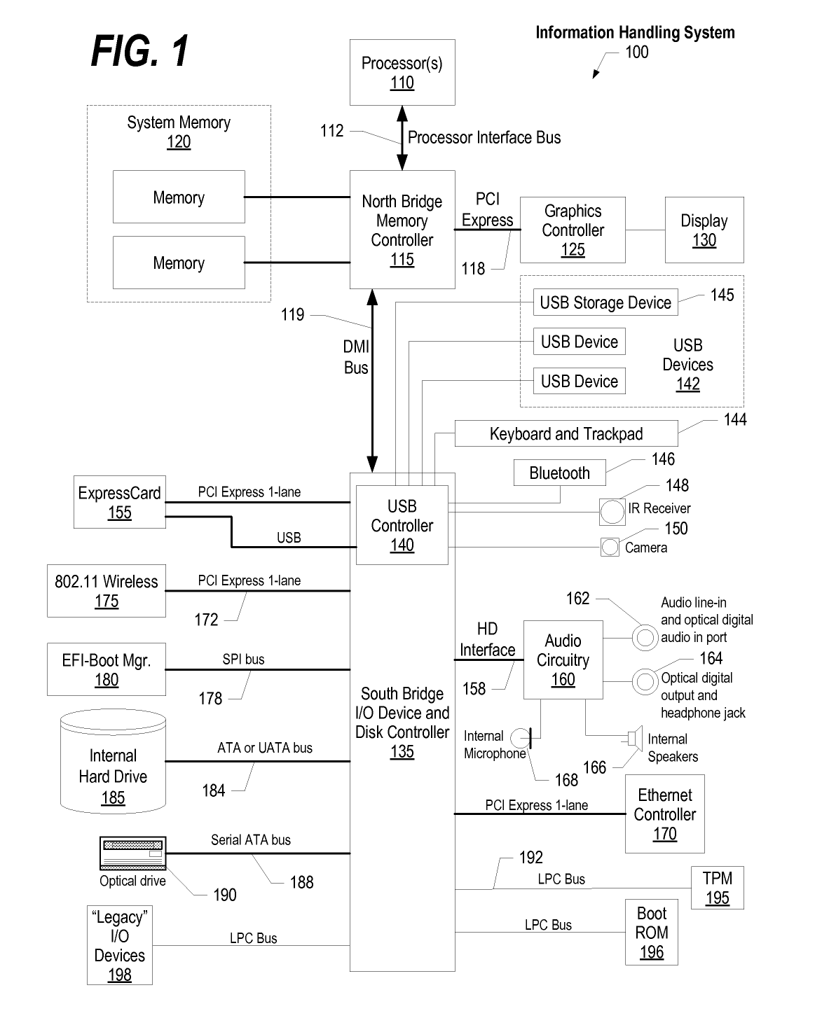

FIG. 1 illustrates information handling system 100, which is a simplified example of a computer system capable of performing the computing operations described herein. Information handling system 100 includes one or more processors 110 coupled to processor interface bus 112. Processor interface bus 112 connects processors 110 to Northbridge 115, which is also known as the Memory Controller Hub (MCH). Northbridge 115 connects to system memory 120 and provides a means for processor(s) 110 to access the system memory. Graphics controller 125 also connects to Northbridge 115. In one embodiment, PCI Express bus 118 connects Northbridge 115 to graphics controller 125. Graphics controller 125 connects to display device 130, such as a computer monitor.

Northbridge 115 and Southbridge 135 connect to each other using bus 119. In one embodiment, the bus is a Direct Media Interface (DMI) bus that transfers data at high speeds in each direction between Northbridge 115 and Southbridge 135. In another embodiment, a Peripheral Component Interconnect (PCI) bus connects the Northbridge and the Southbridge. Southbridge 135, also known as the I/O Controller Hub (ICH) is a chip that generally implements capabilities that operate at slower speeds than the capabilities provided by the Northbridge. Southbridge 135 typically provides various busses used to connect various components. These busses include, for example, PCI and PCI Express busses, an ISA bus, a System Management Bus (SMBus or SMB), and/or a Low Pin Count (LPC) bus. The LPC bus often connects low-bandwidth devices, such as boot ROM 196 and “legacy” I/O devices (using a “super I/O” chip). The “legacy” I/O devices (198) can include, for example, serial and parallel ports, keyboard, mouse, and/or a floppy disk controller. The LPC bus also connects Southbridge 135 to Trusted Platform Module (TPM) 195. Other components often included in Southbridge 135 include a Direct Memory Access (DMA) controller, a Programmable Interrupt Controller (PIC), and a storage device controller, which connects Southbridge 135 to nonvolatile storage device 185, such as a hard disk drive, using bus 184.

ExpressCard 155 is a slot that connects hot-pluggable devices to the information handling system. ExpressCard 155 supports both PCI Express and USB connectivity as it connects to Southbridge 135 using both the Universal Serial Bus (USB) the PCI Express bus. Southbridge 135 includes USB Controller 140 that provides USB connectivity to devices that connect to the USB. These devices include webcam (camera) 150, infrared (IR) receiver 148, keyboard and trackpad 144, and Bluetooth device 146, which provides for wireless personal area networks (PANs). USB Controller 140 also provides USB connectivity to other miscellaneous USB connected devices 142, such as a mouse, removable nonvolatile storage device 145, modems, network cards, ISDN connectors, fax, printers, USB hubs, and many other types of USB connected devices. While removable nonvolatile storage device 145 is shown as a USB-connected device, removable nonvolatile storage device 145 could be connected using a different interface, such as a Firewire interface, etcetera.

Wireless Local Area Network (LAN) device 175 connects to Southbridge 135 via the PCI or PCI Express bus 172. LAN device 175 typically implements one of the IEEE 0.802.11 standards of over-the-air modulation techniques that all use the same protocol to wireless communicate between information handling system 100 and another computer system or device. Optical storage device 190 connects to Southbridge 135 using Serial ATA (SATA) bus 188. Serial ATA adapters and devices communicate over a high-speed serial link. The Serial ATA bus also connects Southbridge 135 to other forms of storage devices, such as hard disk drives. Audio circuitry 160, such as a sound card, connects to Southbridge 135 via bus 158. Audio circuitry 160 also provides functionality such as audio line-in and optical digital audio in port 162, optical digital output and headphone jack 164, internal speakers 166, and internal microphone 168. Ethernet controller 170 connects to Southbridge 135 using a bus, such as the PCI or PCI Express bus. Ethernet controller 170 connects information handling system 100 to a computer network, such as a Local Area Network (LAN), the Internet, and other public and private computer networks.

While FIG. 1 shows one information handling system, an information handling system may take many forms. For example, an information handling system may take the form of a desktop, server, portable, laptop, notebook, or other form factor computer or data processing system. In addition, an information handling system may take other form factors such as a personal digital assistant (PDA), a gaming device, ATM machine, a portable telephone device, a communication device or other devices that include a processor and memory.

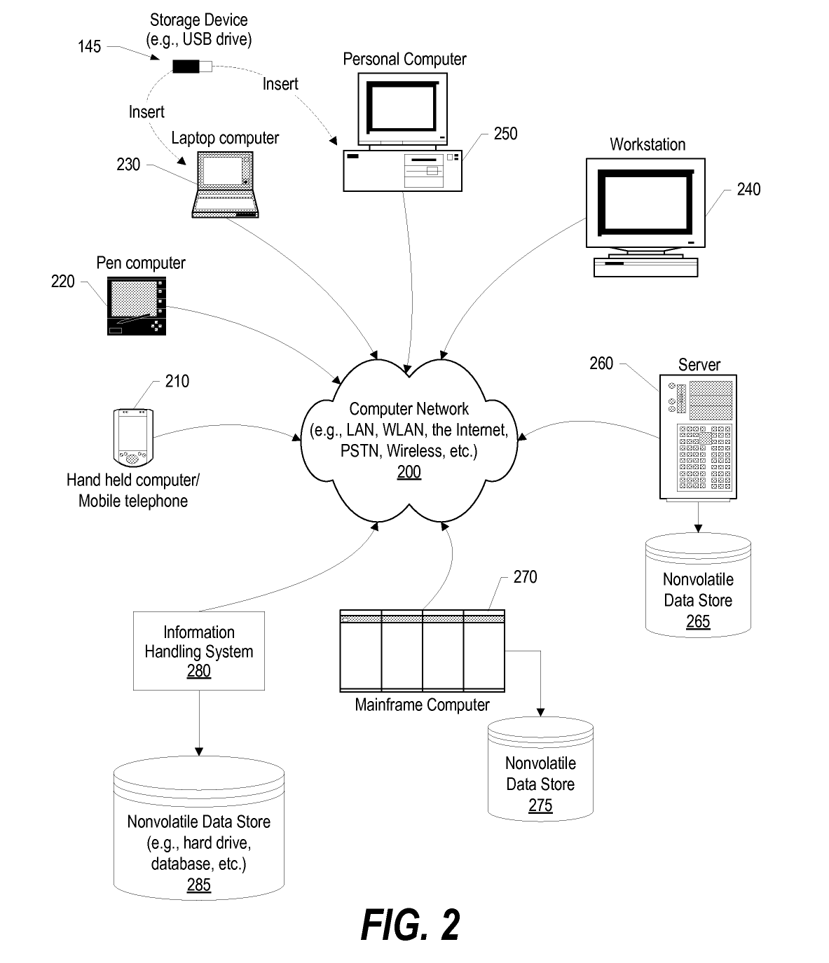

The Trusted Platform Module (TPM 195) shown in FIG. 1 and described herein to provide security functions is but one example of a hardware security module (HSM). Therefore, the TPM described and claimed herein includes any type of HSM including, but not limited to, hardware security devices that conform to the Trusted Computing Groups (TCG) standard, and entitled “Trusted Platform Module (TPM) Specification Version 1.2.” The TPM is a hardware security subsystem that may be incorporated into any number of information handling systems, such as those outlined in FIG. 2.

FIG. 2 provides an extension of the information handling system environment shown in FIG. 1 to illustrate that the methods described herein can be performed on a wide variety of information handling systems that operate in a networked environment. Types of information handling systems range from small handheld devices, such as handheld computer/mobile telephone 210 to large mainframe systems, such as mainframe computer 270. Examples of handheld computer 210 include personal digital assistants (PDAs), personal entertainment devices, such as MP3 players, portable televisions, and compact disc players. Other examples of information handling systems include pen, or tablet, computer 220, laptop, or notebook, computer 230, workstation 240, personal computer system 250, and server 260. Other types of information handling systems that are not individually shown in FIG. 2 are represented by information handling system 280. As shown, the various information handling systems can be networked together using computer network 200. Types of computer network that can be used to interconnect the various information handling systems include Local Area Networks (LANs), Wireless Local Area Networks (WLANs), the Internet, the Public Switched Telephone Network (PSTN), other wireless networks, and any other network topology that can be used to interconnect the information handling systems. Many of the information handling systems include nonvolatile data stores, such as hard drives and/or nonvolatile memory. Some of the information handling systems shown in FIG. 2 depicts separate nonvolatile data stores (server 260 utilizes nonvolatile data store 265, mainframe computer 270 utilizes nonvolatile data store 275, and information handling system 280 utilizes nonvolatile data store 285). The nonvolatile data store can be a component that is external to the various information handling systems or can be internal to one of the information handling systems. In addition, removable nonvolatile storage device 145 can be shared among two or more information handling systems using various techniques, such as connecting the removable nonvolatile storage device 145 to a USB port or other connector of the information handling systems.

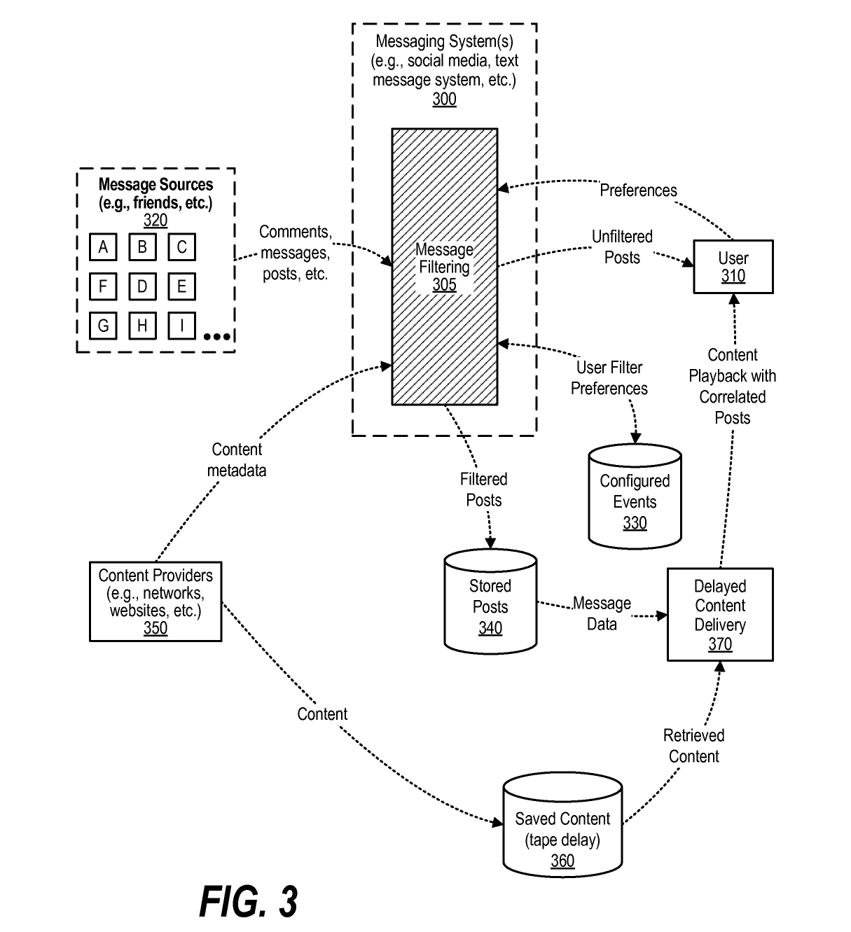

FIGS. 3-8 depict an approach that can be executed on an information handling system, such as a traditional computer system, a smart phone or other mobile device, or any other information handling system, and a computer network, such as the Internet, as shown in FIGS. 1-2. The core idea is to record social media communications, such as posts to a social media platform, text messages, and the like, received while an initial presentation of an event is being performed, such as a sporting event, television program, concert, online event, or the like. The presentation of the event is recorded either by the distributor or publisher, or by the individual user. At a later time, the user watches a recording of the event using a playback mechanism (e.g., digital video recorder (DVR) playback, online playback, etc.) and the system provides the recorded social media communications in sync with the timing of the original social media communications with the original presentation. For example, at the end of the first half of a sporting event, one of the user's friends may have sent the user a text saying, “that was an amazing pass by Jones to close out the half!” The system would then retrieve the recorded social media communications, in this case the text message, and present the text message back to the user at the appropriate time during the playback (at the end of the first half). In addition, in one embodiment, the system automatically compares social media communications directed to the user and filters out the communications not pertaining to the event. In a further embodiment, the filtering mechanism stores social media communications related to the event and further inhibits delivery of the social media communications to the user until playback of the event occurs. In this manner, using the previous example, the user does not see the text message “that was an amazing pass by Jones to close out the half!” until the user is watching the playback of the game with the social media communication appearing at the appropriate time (when the user is watching the playback of the recorded event and the game reaches the halftime at which the original social media communication was received.

Further details and examples depicting various embodiments of the approach that records social media communications and presents them during a later playback of the event are shown in FIGS. 3-8, descriptions of which are found below.

FIG. 3 is a component diagram showing the various components used in detecting and recording social media communications in a collaborative setting. Social media platforms 300, such as a social media website, contemporaneous posting website, etc. includes data filter restrictions 305 that identify social media communications related to an event. User text entries, such as comments, posts, tweets, etc. are submitted by users 320, such as social media “friends,” “colleagues,” “followers,” and the like. Other examples of collaborative environments in addition to social media sites and contemporaneous posting sites include on-line virtual workplaces where employees, students and teachers, friends, colleagues, and the like can communicate, share information and work together. Collaborative environments that include social media platforms can be specifically focused, such as to a particular interest, organization, group, etc. or can have a general focus of interest to users with a wide variety of interests, backgrounds, educations, and the like. In addition, message sources 320 includes non-social media platforms, such as a simple cell phone text message that one of the sources sends to the user's cell phone.

Various sets of content filter data can included in data filter restrictions 305. For example, content filter data can be a content provider set of content filter data, provided by content providers 350. Additionally, content filter data can be user configurable data, such as preferences, configured by user 310 of the collaborative environment. When potential spoiler content is identified by a process running at collaborative environment 300, the process inhibits display of the potential spoiler content to users of the environment, such as user 310. Spoiler content is social media communications that relate to an event that the user plans to watch later, such as a sports event that the user has recorded on the user's digital video recorder (DVR). In one embodiment, the collaborative environment identifies spoiler content according to a semantic analysis that is performed on the received user text entry. During the semantic analysis, the user text entry is parsed and natural language processing is used to extract context-independent aspects of the user text entry's meaning, including the semantic roles of entities mentioned in the user text entry, such as character names found in television episodes, games, sporting events, etc., as well as quantification information, such as cardinality, iteration, and dependency information included in the user text entry.

In one embodiment, further evaluation of the social media communications is performed by comparing the social media communications content to various sets of content filter data. For example, content provider 330 may provide content filter data that provides details about television episodes in a particular series and indicates which episodes are older episodes that are not restricted by the content filter data and which episodes are restricted by the content filter data. If a post made by a user of environment 320 matches one of the non-restricted episodes, such as an older episode, then the post is presented to the user without delay. However, if the social media communications made by the user matches one of the restricted episodes, such as the currently playing episode, then the social media communications are stored in data store 340 and inhibited from display to user 310.

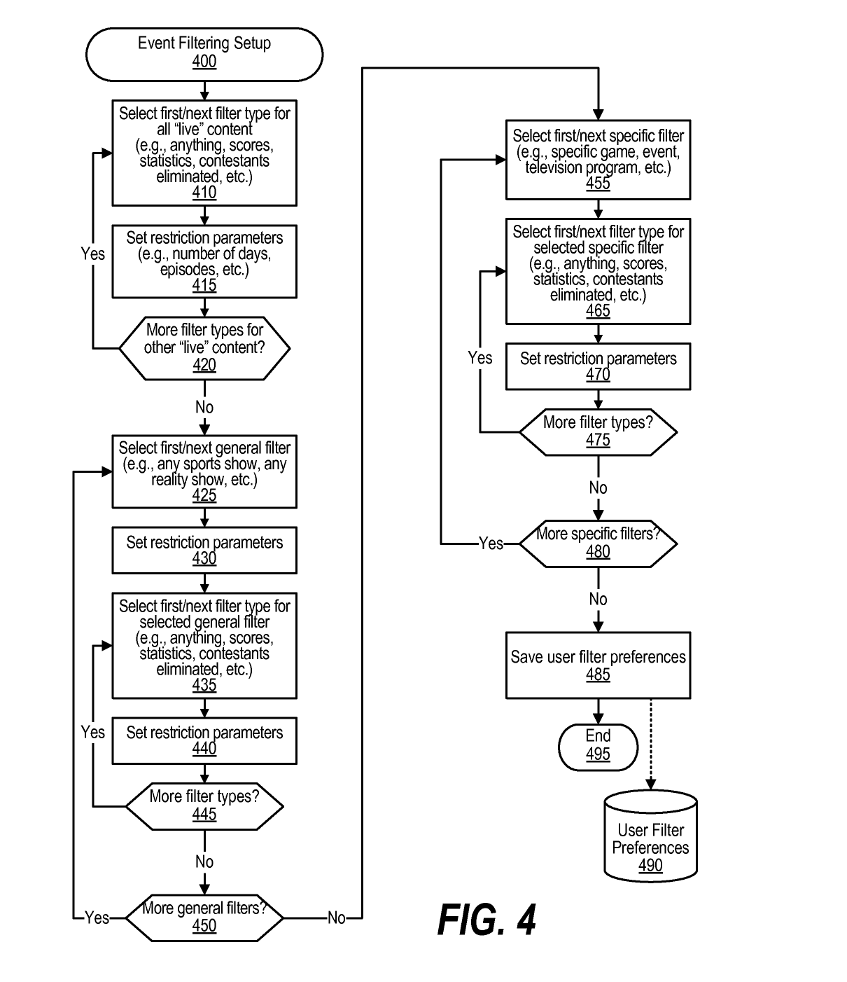

In one embodiment, the user can provide another set of content filter data, such as a set of preferences, that is used to identify spoiler content. This embodiment may be used separately or in conjunction with sets of content filter data provided by content providers 350. For example, the user may indicate that he or she does not follow a particular television series and therefore does not care whether potential social media communications regarding such television series are displayed. In this example, the user's preferences set forth in the content filter data may override content filter data provided by content providers 350 or may be used separately such as in the case when the content provider does not provide content filter data. In this example, the social media communications are displayed to the user based on the user's preferences indicated in the user supplied content filter data. While the user may not be interested in the television series, the user may be interested and wish to avoid seeing social media communications from other television series, other types of content, such as games or live sporting events. Spoiler setup performed by a user to indicate the user's preferences and build a personalized set of content filter data is shown in FIG. 4.

In one embodiment, the user configures the system by adding filter preferences regarding configured events which are stored in data store 330. Configured events include the events, such as sports programs, etc., that the user will be watching after the original broadcast of the event. The events that the user will watch later are stored in saved content data store 360. For example, the user could indicate that he wants to record a particular sports event on the user's DVR which could automatically cause the event to be recorded and stored in data store 360 as well as having the event, and metadata pertaining to the event, added to configured events data store 330. Message filtering system 305 utilizes the configured events data stored in data store 330 to identify social media communications related to a configured event. When a social media communications related to a configured event is identified, such as a text message pertaining to the sports event being recorded, then such related social media communications are stored in data store 340 for future, synchronized presentation to the user during playback of the event. A time delay is used to determine when the social media communication occurred based upon when the event commenced. For example, the time delay may indicate that the social media communications was received one hour after the original event occurred. This delay is also recorded so that, during playback of the event, the stored social media communications can be presented to the user at the appropriate time (e.g., one hour after playback of the event commenced). Delayed content delivery process 370 delivers the recorded event and the stored social media communications to user 310 in a synchronized manner as described above. In one embodiment, social media communications that were originally sent using a variety of platforms are delivered, during playback, to a platform of the user's preference. For example, during the sports event, the user may have been sent three messages, two as cell phone text messages and one via a social media website. However, the user is watching the playback of the event on a network-connected high definition television so the user may indicate that he prefers that the stored social media communications be delivered and presented on the high definition television. Likewise, the user may wish that all of the recorded social media communications be delivered to the user's smart phone at text messages regardless of the platform on which they were initially transmitted.

FIG. 4 is a depiction of a flowchart showing the logic used in spoiler alert user setup processing. Here, “spoilers” refers to social media communications that are directed to an event that the user has indicated he or she wants to watch at a later time. User setup of user-configurable content filter data commences at 400 whereupon, at step 410, the user selects the first content filter type corresponding to “live” content, such as any live content, content containing scores of live events, content containing statistics of live events, content containing contestants competing, eliminated, etc. in a live event, and the like. At step 415, the process receives restriction parameters to use with the selected filter type, such as the number of days the content is considered spoiler data, the number of episodes, etc. A decision is made as to whether there are more filter types that the user wishes to configure for live content (decision 420). If there are additional filter types that the user wishes to configure, then decision 420 branches to the “yes” branch which loops back to select and set the next filter type and restriction parameters as described above. This looping continues until the user does not wish to configure additional live content filters, at which point decision 420 branches to the “no” branch for further user setup processing.

At step 425, the user selects the first general filter that the user wishes to configure (e.g., any sports show, any reality show, any electronic game, etc.). At step 430, the process receives restriction parameters pertaining to the selected general filter (e.g., number of days, episodes, etc.) for which the selected filter is applied. At step 435, the user selects the first content filter type for the selected general filter from step 425. For example, the general filter may be any reality show and the selected filter type, selected at step 435, may be any content pertaining to any reality show, content containing scores pertaining to any reality show, content containing statistics pertaining to any reality show, content containing contestants competing, eliminated, etc. that pertain to any reality show, and the like. At step 440, the process receives restriction parameters to use with the selected filter type for the general filter, such as the number of days the content pertaining to scores in a reality show is considered spoiler data, the number of episodes of reality show data to consider restricted (e.g., the current episode and x previous episodes, etc.), as well as other restriction parameters. A decision is made as to whether there are more filter types that the user wishes to configure for the selected general filter (decision 445). If there are additional filter types that the user wishes to configure, then decision 445 branches to the “yes” branch which loops back to select and set the filter type and receive restriction parameters pertaining to the next selected filter type. This looping continues until the user does not wish to set any additional filter types for the selected general filter, at which point processing branches to the “no” branch. A decision is made as to whether the user wishes to configure additional general filters (decision 450). If the user wishes to configure additional general filters, then decision 450 branches to the “yes” branch which loops back to select the next general filter, the filter types for the next general filter, and the corresponding restriction parameters as described above. This looping continues until the user does not wish to configure additional general filters, at which point decision 450 branches to the “no” branch for user setup processing of specific filters.

At step 455, the user selects the first specific filter, such as a specific game, event, television program, live broadcast, and the like. For example, the user may select a specific television series, a specific sporting event, a specific electronic game, etc. At step 465, the user selects the first content filter type for the selected specific filter that was selected at step 455. For example, the specific filter may be a particular sporting event and the selected filter type, selected at step 465, may be any content pertaining to any aspect of the sporting event, content containing scores pertaining to the sporting event, content containing statistics pertaining the sporting event, content containing contestants competing, eliminated, etc. in the sporting event, and the like. At step 470, the process receives restriction parameters to use with the selected filter type for the specific filter, such as the number of days the content pertaining to scores in the sporting event are considered spoiler data, as well as other restriction parameters. A decision is made as to whether there are more filter types that the user wishes to configure for the selected specific filter (decision 475). If there are additional filter types that the user wishes to configure, then decision 475 branches to the “yes” branch which loops back to select and set the filter type and receive restriction parameters pertaining to the next selected filter type. This looping continues until the user does not wish to set any additional filter types for the selected specific filter, at which point decision 475 branches to the “no” branch. A decision is made as to whether the user wishes to configure additional specific filters, such as additional games, television series, etc. (decision 480). If the user wishes to configure additional specific filters, then decision 480 branches to the “yes” branch which loops back to select the next specific filter, the filter types for the next specific filter, and the corresponding restriction parameters as described above. This looping continues until the user does not wish to configure additional specific filters, at which point decision 480 branches to the “no” branch.

At step 485, the process saves the user configured content filter data in data store 490. User setup of spoiler alert data to use as content filter data thereafter ends at 495.

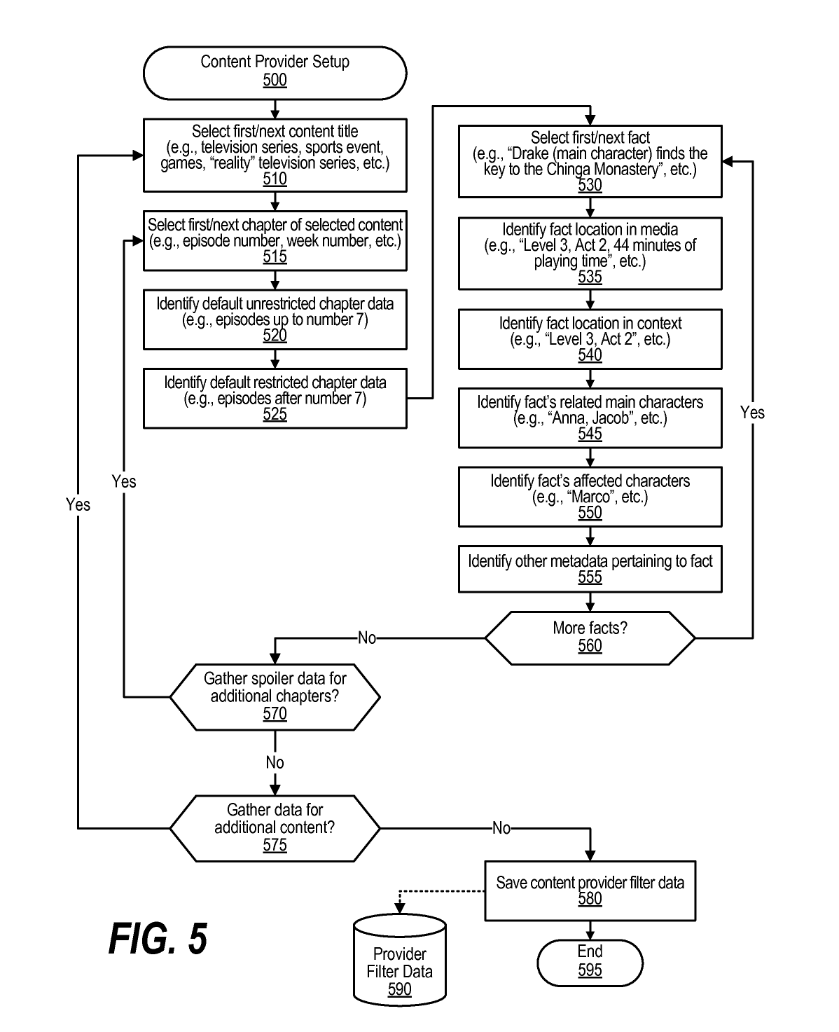

FIG. 5 is a depiction of a flowchart showing the logic used in spoiler alert setup by the content provider. This process, performed by a content provider or perhaps by a user that manages forums or other areas within the collaborative environment where content is discussed, commences at 500 whereupon, at step 510, the provider selects the first content title, such as an television series title, a sports event title, a game title, etc. At step 515, the provider selects the first chapter of the selected content which can be an episode number, a week number, a first release date, etc. At step 520, the provider identifies default unrestricted chapter data, such as a date after which comments and posts concerning the selected chapter will no longer be considered spoiler data. For example, the provider may set the default to be two weeks after the first-aired date. So, using this example, two weeks after the chapter has aired, the default setting would be that comments and posts regarding the selected chapter would no longer be considered spoiler content. Likewise, at step 525, the provider identifies default restricted chapter data, such as a date before which comments and posts concerning the selected chapter are considered to be spoiler comments. Using the example from above, the provider set the default to be two weeks after the first-aired date. So, using this example, for a period of two weeks after the original aired date, the default setting would be that comments and posts regarding the selected chapter would be considered spoiler content. The provider can also set whether comments and posts that occur regarding the episode before the original aired date should be considered spoiler content. For example, speculation about the starters in a sports event may be considered spoiler information even before the sports event is aired.

At steps 530 through 560 facts pertaining to the selected chapter are gathered by the producer to assist the spoiler identification process in its semantic analysis of posts in order to better match posts with content. At step 530, the first fact pertaining to the selected chapter is selected or identified by the provider, such as an action performed by a main character. At step 535, the provider identifies the selected fact's location in the content (media), such as which act the fact occurs, at which time position in the chapter, etc. At step 540, the selected fact's location is identified within the context of the content, such as a level, act, etc. At step 545, related characters to the selected fact are identified. At step 550, affected characters pertaining to the selected fact are identified and, at step 555, any additional metadata pertaining to the selected fact are identified by the provider. A decision is made as to whether there are more facts to describe for the selected chapter (decision 560). If there are more facts to describe, decision 560 branches to the “yes” branch which loops back to select the next fact in the chapter and gather data pertaining to the selected fact as described above. This looping continues until there are no more facts that the provider wishes to describe pertaining to the selected chapter, at which point decision 560 branches to the “no” branch. The gathering of fact data as described above could additionally use other content-related materials, such as scripts, etc. which could be analyzed to gather the facts pertaining to chapters, character involvement, fact location, etc.

A decision is made as to whether there are additional chapters in the content for which the provider is providing spoiler data (decision 570). If there are additional chapters to process, then decision 570 branches to the “yes” branch which loops back to select the next chapter of the selected content, gather the restricted and unrestricted chapter data, and process the facts as described above. This looping continues until there are no more chapters that the provider wishes to describe pertaining to the selected content, at which point decision 570 branches to the “no” branch. A decision is made as to whether there are additional content offerings (e.g., television series, games, etc.) for which the provider is providing spoiler data (decision 575). If there are content offerings to process, then decision 575 branches to the “yes” branch which loops back to select the next content being described by the provider, and gather the chapter data, restriction data, and fact data as described above. This looping continues until there are no more content offerings that the provider wishes to describe, at which point decision 575 branches to the “no” branch.

At step 580, the data gathered by the provider about the content is saved as content filter data in data store 590. Processing of the spoiler alert setup performed by the content provider thereafter ends at 595.

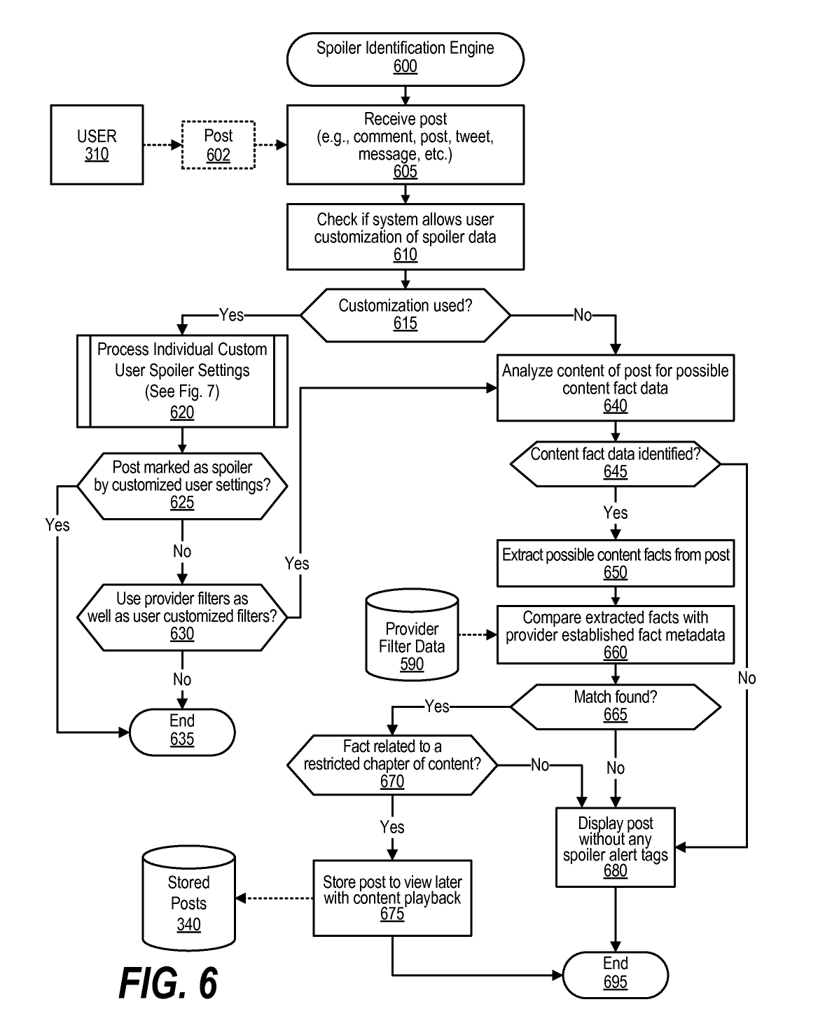

FIG. 6 is a depiction of a flowchart showing the logic used by a spoiler identification engine. Processing of the spoiler identification engine commences at 600 whereupon, the spoiler engine, perhaps running at the collaborative environment's website, receives user text entry 602 (a social media communication) from one of the collaborative environment's users (user 310) at step 605. User text entry is any sort of entry handled by the collaborative environment, such as a comment, post, tweet, message, etc. At step 610, the spoiler identification engine checks whether the engine utilizes user configured content filter data. A decision is made as to whether the spoiler identification engine utilizes customized user configured content filter data (decision 615). If user configured content filter data is being used by the spoiler identification engine, then decision 615 branches to the “yes” branch to process any user configured content filter data.

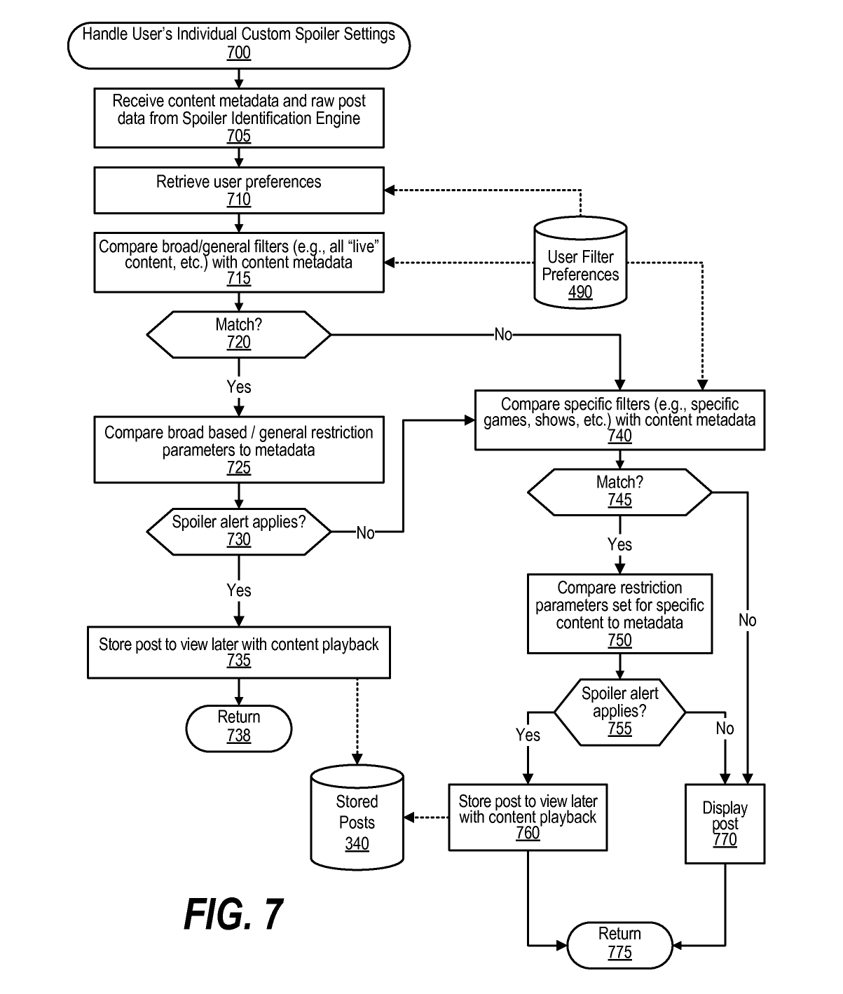

At predefined process 620, the spoiler identification engine processes individual custom user spoiler settings (see FIG. 7 and corresponding text for processing details). Based on the execution of predefined process 620, a decision is made as to whether the user text entry that was received by the spoiler identification engine has been marked as spoiler content by predefined process 620 (decision 625). If the user text entry has already been marked as spoiler content, then decision 625 branches to the “yes” branch and spoiler identification engine processing of the user text entry ends at 635. On the other hand, if the user text entry was not marked as spoiler content by predefined process 620, then decision 625 branches to the “no” branch whereupon a decision is made as to whether the user wishes to utilize additional content filters (e.g., content-provider based content filter data, etc.) at decision 630. If the user has chosen to use additional content filter data if the user's configured content filter data did not mark the user text entry as containing spoiler content, then decision 630 branches to the “yes” branch to continue the filtering process by the spoiler identification engine. On the other hand, if the user only wishes to use the user's configured content filter data, then decision 630 branches to the “no” branch and processing ends at 635 (with the user text entry not being identified as including spoiler content).

If user configured content filter data is not being utilized by the spoiler identification engine (with decision 615 branching to the “no” branch) or if the user configured content filter data did not identify the user text entry as including spoiler content but the user wishes to utilize other available content filter data, such as content-provider content filter data, etc. (with decision 630 branching to the “yes” branch), then step 640 is executed by the spoiler identification engine to analyze the content of the received user text entry in order to identify any possible content fact data (data about content facts, etc.). A decision is made as to whether content fact data was identified (decision 640). If no content fact data was identified, then the user text entry does not include any spoiler content and decision 645 branches to the “no” branch whereupon, at step 680 the user text entry is posted to the collaborative environment without any spoiler tags. For example, if a user posts “I really like this show!”, no facts regarding the content are present in the post and, therefore, the user text entry can be posted without a spoiler alert. On the other hand, if content fact data is identified in the received user text entry submitted to the collaborative environment, then decision 645 branches to the “yes” branch for further analysis.

In one embodiment, the spoiler identification engine performs a semantic analysis on the received user text entry. During the semantic analysis, the user text entry is parsed at step 650 and natural language processing is used to extract context-independent aspects of the user text entry's meaning, including the semantic roles of entities mentioned in the user text entry, such as character names found in television episodes, games, sporting events, etc., as well as quantification information, such as cardinality, iteration, and dependency information included in the user text entry. At step 660, the extracted context-independent aspects of the received user text entry's meaning is compared to the content-provider's content filter data from data store 590 (see FIG. 5 and corresponding text for details regarding the generation of data store 590). A decision is made as to whether a match is identified between the extracted context-independent aspects of the received user text entry's meaning when compared to the content-provider's content filter data (decision 665). If a match is not found, the facts in the post do not match restricted facts in the content chapters and, therefore, the user text entry is deemed to not include spoiler content. In this case, decision 665 branches to the “no” branch whereupon, at step 680 the user text entry is posted to the collaborative environment without any spoiler tags.

On the other hand, if a match is identified between the extracted context-independent aspects of the received user text entry's meaning and the content-provider's content filter data, then decision 665 branches to the “yes” branch for further analysis. A decision is made as to whether the facts in the user text entry relate to a restricted chapter of content (decision 670). If the facts in the user text entry do not relate to a restricted chapter of content, perhaps they relate to an older episode, etc., then decision 670 branches to the “no” branch whereupon, at step 680 the user text entry is posted to the collaborative environment without any spoiler tags. On the other hand, if the facts in the user text entry relate to a restricted chapter of content, such as a program that the user is recording, etc., then decision 670 branches to the “yes” branch whereupon, at step 675, the received social media communications is stored in data store 340 for delayed presentation to the user when the user is watching a recording of the event. After the social media communication has been processed and either displayed without a spoiler alert tag or after inclusion of a spoiler alert tag and stored in data store 340 for delayed presentation, processing by the spoiler identification engine ends at 695. Note that when user configured content filter data are being used in the collaborative environment, the spoiler identification engine processing shown in FIG. 6 would be performed for each of the recipients (users of the collaborative environment) since each of the collaborative environment users can have different user configured content filter data. Also, in one embodiment, the spoiler identification engine periodically re-evaluates spoiler content using the steps described above to ascertain whether the post is still considered spoiler content. For example, if the user text entry was a post about a television episode that just aired, then the post might be identified as containing spoiler content and have a spoiler tag included. However, after the user has watched the recorded version of the event, re-evaluation of the post by the spoiler identification engine would determine that the social media communication no longer includes spoiler content (as the event has been watched by the user), so the spoiler tag could be removed and the original user text entry would appear in the collaborative environment.

FIG. 7 is a depiction of a flowchart showing the logic performed to handle a user's individual custom spoiler settings. Processing of the routine, which is performed by the spoiler identification engine in one embodiment, commences at 700 whereupon, at step 705 the content metadata and raw user text entry are received from the calling routine in the spoiler identification engine. At step 710, user preferences set by the user when establishing the user configured content filter data are retrieved. At step 715, the broad based content filter data filters, such as those that apply to all content or a wide assortment of content, are applied to the user text entry using the spoiler identification engine's semantic analysis routine. During the semantic analysis, the user text entry is parsed and natural language processing is used to extract context-independent aspects of the user text entry's meaning, including the semantic roles of entities mentioned in the user text entry, such as character names found in television episodes, games, sporting events, etc., as well as quantification information, such as cardinality, iteration, and dependency information included in the user text entry. At step 715, the extracted context-independent aspects of the received user text entry's meaning is compared to the broad-based user configured content filter data from data store 490 (see FIG. 4 and corresponding text for details regarding the generation of data store 490).

A decision is made as to whether the extracted context-independent aspects of the received user text entry's meaning match the broad-based user configured content filter data (decision 720). If a match is found, then decision 720 branches to the “yes” branch whereupon, at step 725, the broad-based user configured content filter data restrictions are compared to the potential spoiler content included in the user text entry. A decision is made as to whether the facts in the user text entry relate to a restriction set by a broad based filter (decision 730). If the facts in the user text entry do not relate to a restricted broad-based filter, then decision 730 branches to the “no” branch for further analysis to determine whether a user configured specific content filter data applies. On the other hand, if the facts in the user text entry relate to a restricted broad-based filter, then decision 730 branches to the “yes” branch whereupon, at step 735, the process stores the received post (social media communication) in data store 340. In addition, the process stores the time at which the social media communications was received establishing a time delay so that the recorded social media communications can be presented during playback of the recorded event at the appropriate time during playback. Processing thereafter returns to the calling routine (see FIG. 6) at 738.

If the contents of the user text entry did not match any broad based user configured content filter data (decision 720 branching to the “no” branch) or if it was determined that the user configured broad based filters did not apply to the user text entry (decision 730 branching to the “no” branch), then analysis of user configured specific content filter data is performed starting at step 740 where the user configured specific content filter data is compared with the contents of the user text entry using the semantic analysis as discussed in relation to the broad based filters but here the semantic analysis is performed using the specific user configured content filter data. A decision is made as to whether the facts in the user text entry relate to a restriction set by a specific based content filter (decision 745). If the facts in the user text entry do not relate to a specific user configured content filter, then decision 745 branches to the “no” branch whereupon, at step 770 the user text entry is posted to the user's collaborative environment area without any spoiler tags. Of course, another user of the collaborative environment might have configured different settings where the same user text entry (post) is protected with a spoiler tag.

On the other hand, if the facts in the user text entry relates to a restricted specific-based user configured filter, then decision 745 branches to the “yes” branch whereupon, at step 750, the specific-based user configured content filter data restrictions are compared to the potential spoiler content included in the user text entry. A decision is made as to whether the facts in the user text entry relate to a restriction set by a broad based filter (decision 755). If the facts in the user text entry are not restricted based on a specific-based filter, then decision 755 branches to the “no” branch, whereupon at step 770 the user text entry is posted to the user's collaborative environment area without any spoiler tags. Once again, another user of the collaborative environment might have configured different settings where the same user text entry (post) is protected with a spoiler tag.

On the other hand, if the facts in the user text entry relate to a restricted specific-based filter that applies to the user text entry, then decision 755 branches to the “yes” branch whereupon, at step 760, process stores the received post (social media communication) in data store 340. In addition, the process stores the time at which the social media communications was received establishing a time delay so that the recorded social media communications can be presented during playback of the recorded event at the appropriate time during playback. Processing thereafter returns to the calling routine (see FIG. 6) at 775.

Also, in one embodiment, similar to the spoiler processing shown in FIG. 6, in FIG. 7, the spoiler identification engine periodically re-evaluates spoiler content using the steps described above to ascertain whether the post is still considered spoiler content. For example, if the user text entry was a post about a television episode that just aired, then the post might be identified as containing spoiler content and have a spoiler tag included. However, after the user watches the recorded version of the event, the user's configured content filter data might indicate that the spoiler content is no longer spoiler content. Therefore, the re-evaluation of the post by the spoiler identification engine would determine that the post no longer includes spoiler content (as the content is now older), so the spoiler tag could be removed and the original user text entry would appear to the user instead of the spoiler tag.

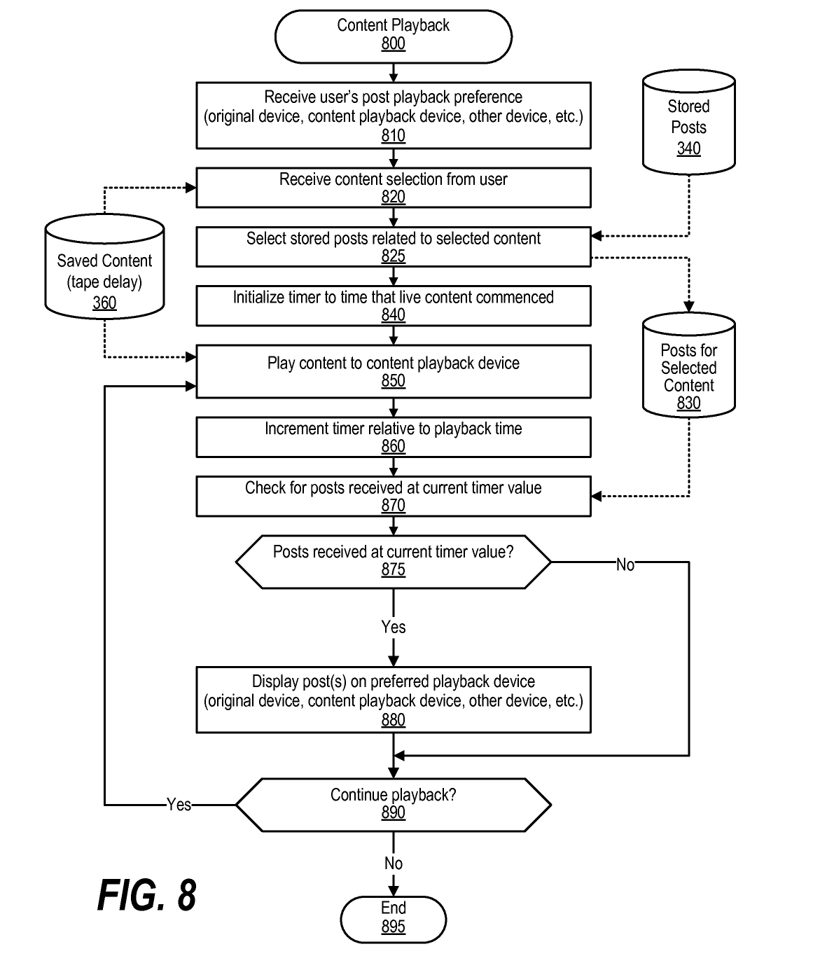

FIG. 8 is a depiction of a flowchart showing the logic used to playback recorded content along with a synchronized rendering of the posts that occurred during the original performance of the content. Processing commences at 800 whereupon, at step 810, the system retrieves the user's playback preference regarding how the user wishes to view the social media communications retrieved during playback. For example, the user can select to have the social media communications delivered to the original device (social media platform) to which they were originally directed, to the same device that the user is using to watch the playback (e.g., a network-connected high definition television, etc.), or another device (e.g., sent to the user's smart phone while the user is watching the playback on the high definition television).

At step 820, the system receives the playback event selection from the user with the user selecting from a set of saved event content stored in data store 360. Some events may have been stored to the user's local recording device, such as a DVR, etc., while other events may be stored at a content provider, such as the broadcaster, event host, etc., using on-demand technology.

At step 825, the system selects social media communications stored in data store 340 that pertain to the selected event that is being played back to the user. The social media communications relating to the selected event are stored in data store 830 for delivery during playback presentation.

At step 840, the system initializes a timer so that presentation of the social media communications can be synchronized to occur at times coinciding when the original social media communications were received during the initial presentation of the event. At step 850, the system commences playback of the recorded event to the user at the user's designated playback device. At step 860, throughout the playback process, the timer is continually incremented to coincide with the amount of the recorded event that has been played to the user. At step 870, the system checks the social media communications stored in data store 830 and compares the delay time of the social media communications with the current delay time established by the timer. A determination is made as to whether any social media communications were received at the current (incremented) timer value decision 875). If one or more social media communications were received at the current timer value, then decision 875 branches to the “yes” branch whereupon, at step 880, the social media communications that were received at the current timer value are displayed to the user on the playback device designated by the user. On the other hand, if no social media communications were received at the current timer value, then decision 875 branches to the “no” branch bypassing step 880.

A determination is made as to whether to continue playback (decision 890). If playback has not completed, then decision 890 branches to the “yes” branch which loops back to continue playback of the recorded event, incrementing the timer, and displaying time-appropriate social media communications as outlined above. This looping continues until playback is terminated (either the entire event has been played back to the user or the user stops playback of the event), at which point decision 890 branches to the “no” branch whereupon processing ends at 895.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While particular embodiments of the present invention have been shown and described, it will be obvious to those skilled in the art that, based upon the teachings herein, that changes and modifications may be made without departing from this invention and its broader aspects. Therefore, the appended claims are to encompass within their scope all such changes and modifications as are within the true spirit and scope of this invention. Furthermore, it is to be understood that the invention is solely defined by the appended claims. It will be understood by those with skill in the art that if a specific number of an introduced claim element is intended, such intent will be explicitly recited in the claim, and in the absence of such recitation no such limitation is present. For non-limiting example, as an aid to understanding, the following appended claims contain usage of the introductory phrases “at least one” and “one or more” to introduce claim elements. However, the use of such phrases should not be construed to imply that the introduction of a claim element by the indefinite articles “a” or “an” limits any particular claim containing such introduced claim element to inventions containing only one such element, even when the same claim includes the introductory phrases “one or more” or “at least one” and indefinite articles such as “a” or “an”; the same holds true for the use in the claims of definite articles.

1. A method of delaying presentation of social media communications corresponding to an event, the method, implemented by an information handling system, comprising:
selecting a plurality of restricted social media communications from a larger set of social media communications directed to a user during an initial presentation of the event, wherein the selecting further comprises:
comparing a content of each of the social media communications included in the larger set of social media communications with a set of content filter data pertaining to the content, wherein the set of content filter data comprises one or more user filter preferences and one or more content provider filter data, and wherein the plurality of restricted social media communications is selected based on the comparison;
storing the plurality of restricted social media communications;
recording a time delay associated with each of the restricted social media communications from a first start time associated with the initial presentation of the event;
during subsequent playback of the event:
retrieving the restricted stored social media communications; and
presenting the retrieved restricted social media communications based upon the time delay associated with each of the restricted social media communications from a second start time associated with the subsequent playback of the event.

2. (canceled)

3. The method of claim 1 wherein the larger set of social media communications are directed to a plurality of social media platforms.

4. The method of claim 3 further comprising:
identifying a preferred social media playback platform, wherein the presentation of the retrieved restricted social media communications is performed using the identified social media playback platform.

5. The method of claim 4 wherein the identified social media playback platform is also used to deliver the subsequent playback of the event.

6. The method of claim 1 further comprising:
receiving an event selection from a user prior to the first start time associated with the initial presentation of the event; and
retrieving event metadata corresponding to the event selection, wherein the set of content filter data is further based on the event metadata.

7. The method of claim 1 wherein the event includes an event type that is selected from a group consisting of a sports event, a live performance, a television program, and a computer network broadcast.

8. The method of claim 1 wherein the content provider filter data comprises chapter data and fact data related to the event.
